(19) United States
(12) Patent Application Publication
(10) Pub. No.: US 2025/0147779 A1
(43) Pub. Date: May 8, 2025

(54) USER INTERFACE WITH INTERACTION MODEL FOR INTERACTING BETWEEN DISPLAYS

(71) Applicant: Atieva, Inc., Newark, CA (US)

(72) Inventors: Eui Chan Choi, Newark, CA (US); Colin Sebestyen, Newark, CA (US); Divya Seshadri, Newark, CA (US); Dave Wayne Flynt, Newark, CA (US); Rodrigo Cardenas Islas Bustamante, Newark, CA (US); Sepehr Pourrezaei Khaligh, Newark, CA (US); Perry Wesley Chan, Newark, CA (US); Nitendra Gurung, Newark, CA (US); Carl Hewitt, Newark, CA (US); Paul Hsu, Newark, CA (US); Shuo Yuan, Newark, CA (US); Jack Cong, Newark, CA (US); Vishal Pallikandi, Newark, CA (US); Daniel Deryee Leung, Newark, CA (US); Yunwei Yang, Newark, CA (US); Veena Kumari, Newark, CA (US); Raymond Bessemer, Newark, CA (US); Bill Rainey, Newark, CA (US)

(21) Appl. No.: 18/902,386

(22) Filed: Sep. 30, 2024

Related U.S. Application Data
(60) Provisional application No. 63/596,931, filed on Nov. 7, 2023.

(51) Int. Cl. G06F 9/451; B60K 35/22; G06F 3/04883; G06F 3/14

(52) U.S. Cl. CPC G06F 9/451; B60K 35/22; G06F 3/04883; G06F 3/1423

(57) ABSTRACT

This disclosure provides systems, devices, apparatus, and methods, including computer programs encoded on storage media, for performing interaction between displays of an automobile. In some implementations, the method may include displaying, on a first screen, a first graphical user interface (GUI) including multiple regions, a first region including multiple graphical representations, each graphical representation representing a respective application through which a user can interact with the respective application. In addition, the method may include detecting a user input on a selected graphical representation of the multiple graphical representations on the first GUI. The method may include in response to the detecting the user input, launching, on a second screen different from the first screen, the application corresponding to the selected graphical representation, the application being displayed on a second GUI of the second screen while displaying the graphical representation of the application on the first screen.

### CROSS-REFERENCE TO RELATED APPLICATIONS

This application claims the benefit of U.S. Provisional Patent Application No. 63/596,931, filed 7 Nov. 2023 the disclosure of which is incorporated herein by reference in its entirety.

### TECHNICAL FIELD

The present disclosure relates generally to automobiles, and more particularly, to an interaction model for interacting between user interface displays of the automobiles.

### BACKGROUND

As society becomes increasingly fast-paced and interconnected, drivers and passengers may seek an elevated experience in their vehicles while on the road and otherwise. Advanced automotive systems include display screens to augment the layout and control of a traditional dashboard. For example, advanced infotainment systems offer a wide range of features, such as touchscreen displays and smartphone integration, which allows passengers of the vehicle to access technological features and services with ease. Furthermore, the integration of smart display screens into automobile systems can assist the drivers in managing various tasks with reduced driving distractions. Accordingly, there is a need for automobile manufacturers to develop technologies that can reduce, and potentially minimize, driving distraction for providing an elevated user experience to the drivers and passengers.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In aspects of the disclosure, a method, a computer-readable medium, and an apparatus are provided. In some embodiments, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some embodiments, a method includes displaying, on a first screen, a first graphical user interface (GUI) including multiple regions, a first region including multiple graphical representations, each graphical representation representing a respective application through which a user can interact with the respective application. Method may also include detecting a user input on a selected graphical representation of the multiple graphical representations on the first GUI. Method may furthermore include in response to the detecting the user input, launching, on a second screen different from the first screen, the application corresponding to the selected graphical representation, the application being displayed on a second GUI of the second screen while displaying the graphical representation of the application on the first screen. Other embodiments of this aspect include corresponding computer systems, apparatus, and computer programs recorded on one or more computer storage devices, each configured to perform the actions of the methods.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### DESCRIPTION OF THE DRAWINGS

FIG. 1A is a block diagram illustrating an example of an automotive system involved in synchronizing a display of an application on multiple screens of an automotive system.

FIG. 1B is a diagram illustrating an example of a view of a visual display system for an automobile showing an automotive dual screen system with a first screen and a second screen.

FIG. 2A is a diagram illustrating an example of an automotive dual screen system including a first graphical user interface (GUI) displaying multiple graphical representations.

FIG. 2B is a diagram illustrating an example of an automotive dual screen system including a second graphical user interface (GUI) displaying a graphical representation in response to a user input.

FIG. 2C is a diagram illustrating an example of an automotive dual screen system including a second graphical user interface (GUI) displaying an expanded view of the graphical representation that includes more in-depth information of the associated application, in response to a user input.

FIG. 3A is diagram illustrating an example of an automotive dual screen system including a second graphical user interface (GUI) displaying an expanded view of the graphical representation that includes more in-depth information of the associated application.

FIG. 3B is a diagram illustrating another example of an automotive dual screen system including a second graphical user interface (GUI) displaying an expanded view of the graphical representation that includes more in-depth information of the associated application.

FIG. 4 is a flowchart of a method of synchronizing a display of an application on multiple screens of an automotive system.

FIG. 5 is a diagram illustrating an automotive dual screen system.

FIG. 6 illustrates system level diagram of a vehicle according to some embodiments of the disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects are presented with reference to various apparatus and methods. These apparatus and methods are described in the following detailed description and illustrated in the accompanying drawings by various blocks, components, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip, baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

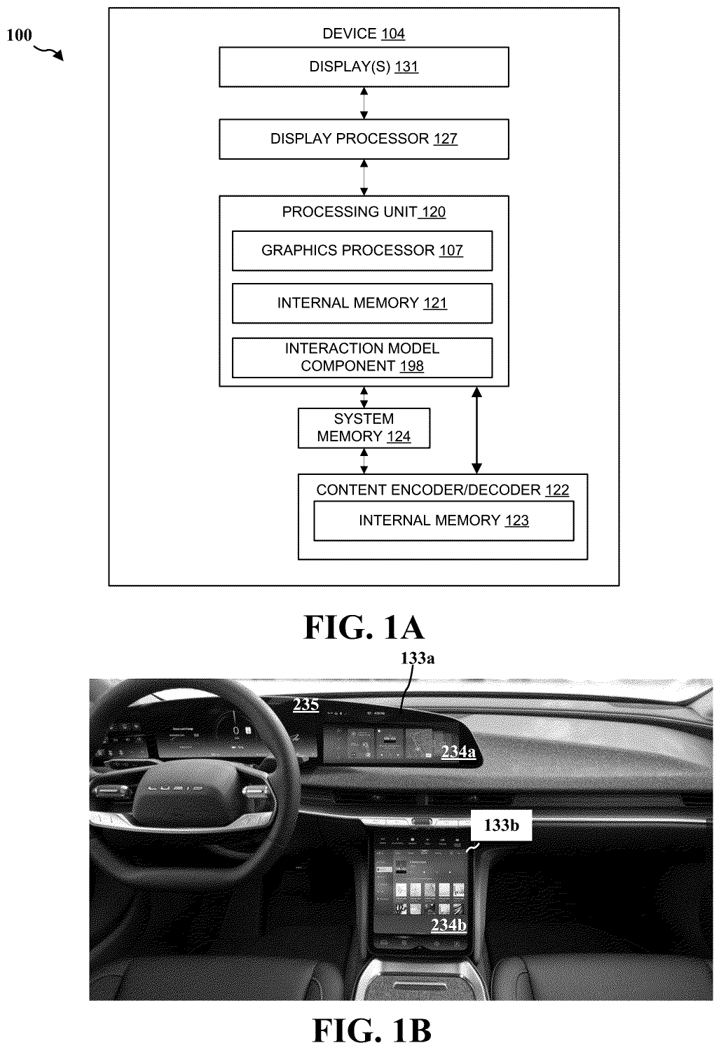

FIG. 1A is a block diagram illustrating an example of an automotive system 100 having a display system that is able to in synchronize content of an application on multiple screens of an automotive system. The automotive system 100 includes a computing device 104 that has one or more components or circuits for performing various functions described herein. The computing device 104 may include one or more displays 131, a display processor 127, a processing unit 120, a system memory 124, a content encoder/decoder 122, etc. In some embodiments, the computing device 104 is an automobile. Multiple displays 131 associated with the device 104 can be configured to display different instances of a same software application on different displays 131 at a same time.

Now referring to FIG. 1B, in some embodiments, graphics processing results/graphical content associated with an output of a software application can be displayed using graphical user interface(s) (GUI) 133a-133b on the display(s) 131. For example, a first GUI 234a may be associated with a cockpit panel/display 235 and a second GUI 234b may be associated with a central information display unit (CIDU) and both of these displays can display content from the same software application at the same time. In some embodiments, the content is synchronized so that both displays show the same content. In some other embodiments, the graphical processing results/graphical content can be transferred to another device for display.

With reference to FIGS. 1A-1B, the processing unit 120 can include a graphics processor 107 and an internal memory 121. The processing unit 120 can be configured to perform graphics processing using the graphics processor 107 (e.g., based on a graphics processing pipeline). The processing unit 120 can also generate the graphical content displayed through the GUI(s) 133a-133b. The processing unit 120 further includes an interaction model component 198, as will be discussed in further detail below, for performing various aspects and functionality described herein.

The display processor 127 can be configured to perform one or more display processing techniques on one or more frames/graphical content generated by the processing unit 120 before the frames/graphical content is displayed through the GUI 133a-133b on the one or more displays 131. While the example automotive system 100 illustrates a display processor 127, it should be understood that the display processor 127 is one example of a processor that can perform the functions descried herein and that other types of processors, controllers, etc., can be used as a substitute for the display processor 127 to perform each of the functions described herein. The one or more displays 131 can be configured to display or otherwise present graphical content processed/output by the display processor 127. In some embodiments, the one or more displays 131 can include a liquid crystal display (LCD), a plasma display, an organic light emitting diode (OLED) display, a projection display device, a touchscreen, a touch surface, or any other type of display device or panel.

Memory external to the processing unit 120 and the content encoder/decoder 122, such as system memory 124, can be accessible to the processing unit 120 and the content encoder/decoder 122. For example, the processing unit 120 and the content encoder/decoder 122 can be configured to read from and/or write to external memory, such as the system memory 124. The processing unit 120 includes the internal memory 121. The content encoder/decoder 122 can also include an internal memory 123. The processing unit 120 and the content encoder/decoder 122 can be communicatively coupled to the system memory 124 over a bus. In some examples, the processing unit 120 and the content encoder/decoder 122 can be communicatively coupled to the internal memories 121/123 over the bus or via a different connection. The content encoder/decoder 122 can be configured to receive graphical content from any source, such as the system memory 124 and/or the processing unit 120 and encode or decode the graphical content. In some examples, the graphical content can be in the form of encoded or decoded pixel data. The system memory 124 can be configured to store the graphical content in an encoded or decoded form.

The internal memories 121/123 and/or the system memory 124 can include one or more volatile or non-volatile memories or storage devices. In some examples, internal memories 121/123 or the system memory 124 can include RAM, static random access memory (SRAM), dynamic random access memory (DRAM), erasable programmable ROM (EPROM), EEPROM, flash memory, a magnetic data media, optical storage media, or any other type of memory. The internal memories 121/123 or the system memory 124 can be a non-transitory storage medium according to some examples. The term “non-transitory” can indicate that the storage medium is not embodied in a carrier wave or a propagated signal. However, the term “non-transitory” should not be interpreted to mean that the internal memories 121/123 or the system memory 124 is non-movable or that its contents are static. In some embodiments, the system memory 124 can be removed from the device 104 and moved to another device. As another example, the system memory 124 cannot be removable from the device 104.

The processing unit 120 can be a central processing unit (CPU), a graphics processing unit (GPU), or any other processing unit that can be configured to provide content for display. The content encoder/decoder 122 can be any processor configured to perform content encoding and content decoding. In some examples, the processing unit 120 and/or the content encoder/decoder 122 can be integrated into a motherboard of the device 104. The processing unit 120 can be present on a graphics card that is installed in a port of the motherboard of the device 104 or can be otherwise incorporated within a peripheral device configured to interoperate with the device 104. The processing unit 120 and/or the content encoder/decoder 122 can include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combination thereof. If the techniques are implemented partially in software, the processing unit 120 and/or the content encoder/decoder 122 can store instructions for the software in a suitable, non-transitory computer-readable storage medium (e.g., memory) and can execute the instructions in hardware using one or more processors to perform the techniques of this disclosure. Any of the foregoing, including hardware, software, a combination of hardware and software, etc., can be considered to be one or more processors.

In certain aspects, the processing unit 120 (e.g., CPU, GPU, etc.) can include an interaction model component 198, which can include software, hardware, firmware, or a combination thereof for synchronizing a display of an application on multiple screens of a vehicle and configured to: display, on a first screen, a first graphical user interface (GUI) including multiple regions, a first region including multiple graphical representations, each graphical representation representing a respective application through which a user can interact with the respective application; detect a user input on a selected graphical representation of the multiple graphical representations on the first GUI; in response to the detecting the user input, launch, on a second screen different from the first screen, the application corresponding to the selected graphical representation, the application being displayed on a second GUI of the second screen while displaying the graphical representation of the application on the first screen. Although the following description can be focused on synchronizing a display of an application on multiple screens of a vehicle, the concepts described herein can be applicable to other similar processing.

FIG. 1B is a diagram illustrating an example of a view of a cockpit of an automobile showing an automotive dual screen system with a first screen and a second screen. In the illustrated example, the automotive dual screen system includes a first screen 133a and a second screen 133b. In this example, the first screen 133a is positioned above the second screen 133b within an interior of the automobile. The first screen 133a is positioned to the right of the steering wheel. It should be understood that the terms “first screen,” “upper screen,” and “home screen” can be used interchangeably throughout this disclosure. It should also be understood that the terms “second screen,” “lower screen,” and “pilot panel” can be used interchangeably throughout this disclosure.

The first screen includes a first GUI 234a. The first GUI 234a can display mobile phone, media, navigation and applications. The first GUI 234a is configured for controlling the display on the first screen 133a. Similarly, positioned lower on the dashboard, the second screen 133b includes a second GUI 234b. The first GUI 234a and the second GUI 234b can be used for controlling operations of one or more software applications displaying content on the first GUI 234a and the second GUI 234b on the display on the first screen 133a and the second screen 133b, respectively. The second GUI 234b can display functions such as seat function, car drive mode, climate control, and all other vehicle settings. In some embodiments, the user can perform a swipe gesture on a graphical representation to cause content displayed on the home screen to be displayed on the pilot panel and vice versa. This content can include the display of in-depth controls and in-depth information of an application. In-depth controls can include various functions for drive modes, the doors, the seats, the interior lighting, and the cabin temperature. In-depth information of an application can include detailed information related to the selected application. For example, when a user selects a media application, the in-depth information of the media application can include media source selectors, a selected media title, available media title, and a menu bar.

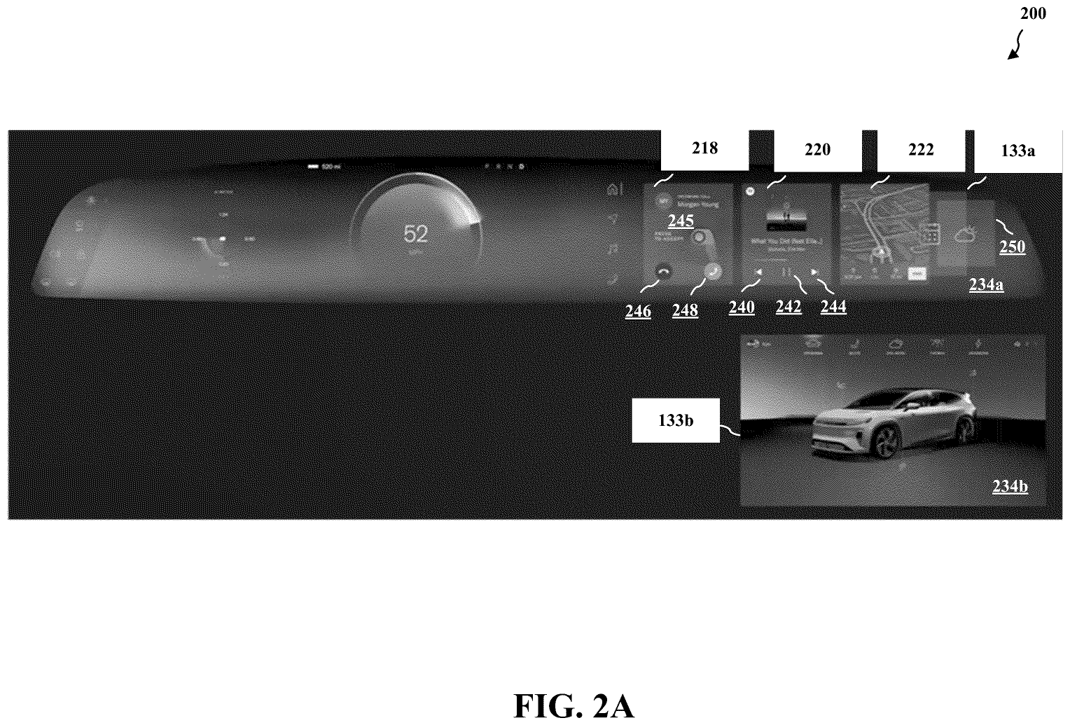

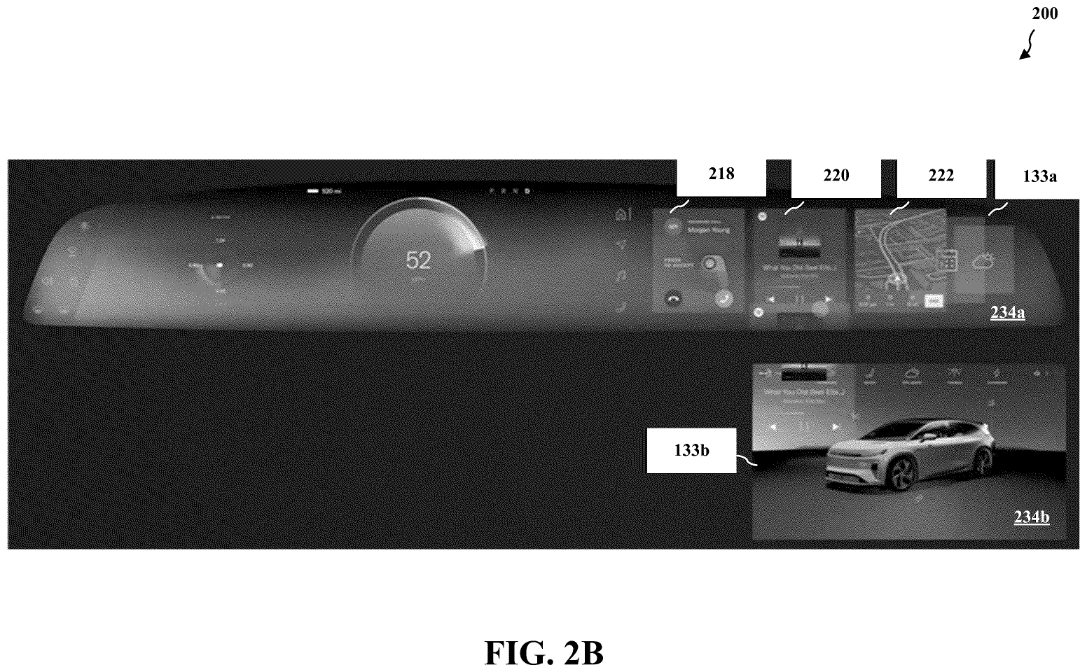

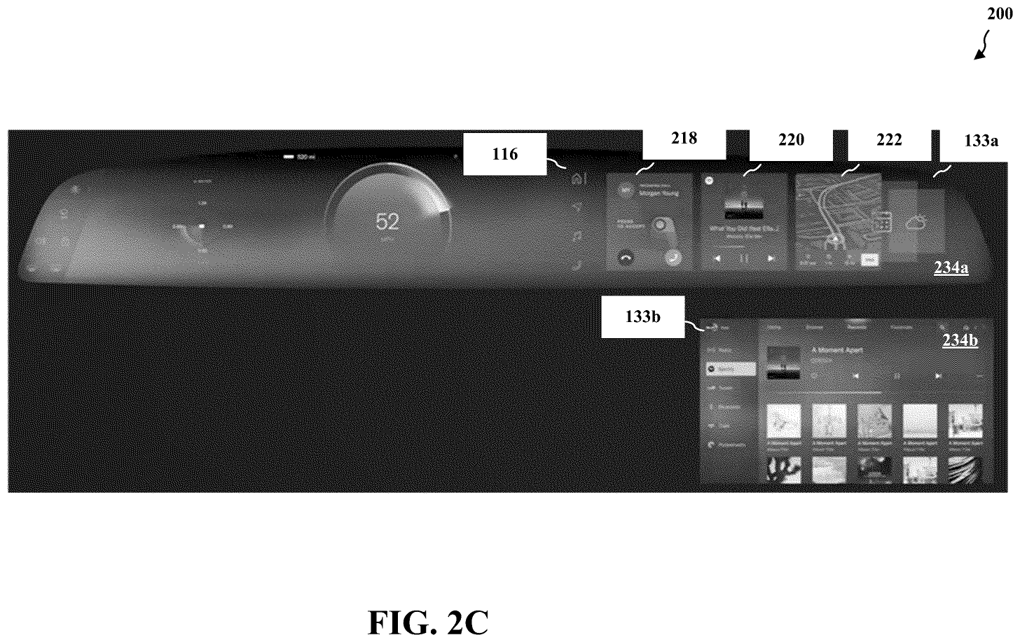

FIGS. 2A-2C illustrate an automotive multiple screen system displaying GUIs on multiple display screens that uses a dual screen interaction model having various features in some embodiments. Although described herein with reference to two screens, interaction models and the GUI can be developed for portions of a single screen, or for screen systems with more than two display screens, in some embodiments.

FIG. 2A is a diagram illustrating an example of an automotive dual screen system including a first graphical user interface (GUI) displaying multiple graphical representations. As shown, FIG. 2A depicts some embodiments of an automotive dual screen system 200 displaying a first GUI 234a and a second GUI 234b. The first GUI 234a can be displayed on a first screen 133a and the second GUI 234b can be displayed on a second screen 133b. The first GUI 234a and the second GUI 234b can be generated by a display processor 127 coupled to the two screens 133a, 133b (see, e.g., FIG. 1A).

In some embodiments, the first screen 133a can be positioned above the second screen 133b. In some embodiments, as shown in FIGS. 1B, 2A-2C, an automotive dual screen system includes an upper screen 133a with a panoramic view positioned above a lower screen 133b with a landscape view. In some embodiments, the first screen and the second screen are juxtaposed according to a predefined relative orientation. For example, the upper screen 133a is positioned to the left of the lower screen 133b. Although the second screen 133b is illustrated positioned below the first screen 133a, it will be appreciated that the second screen 133b could be positioned at various other possible positions (e.g., to the right of the first screen 133a, etc.).

The first GUI 234a can be divided into multiple regions. A first region of the first GUI 234a displays multiple graphical representations 218, 220, 222 with each being displayed in a separate sub-region. Each of the multiple graphical representations 218, 220, 222 represents a respective application through which a user can interact with the respective application. It should be understood that the terms “application” and “app” arc used interchangeably throughout this disclosure.

Referring to FIG. 2A, a first graphical representation 218 displays action soft buttons selectable that, when selected, perform corresponding functions associated with the application (e.g., a mobile phone application). The graphical representation 218 provides an overview of some key functions of a corresponding application. In some embodiments, the graphical representation 218 shows an incoming call notification 245. The first graphical representation 218 displays action soft buttons (e.g., decline call 246 or accept call 248). Each graphical representation can function by selecting various action soft buttons. The action soft buttons allow the user to access commands directly on the graphical representation without the need to launch a full screen application view. The action soft button can be configured based on the user preference.

In some other embodiments, the graphical representation 218 displays different content associated with the graphical representation. For example, the graphical representation 218 can display information indicating there is an incoming call. The graphical representation 218 can display recent contacts if there is no incoming call. Based on the display of the recent contacts, the driver can initiate a call to one of the recent contacts. In some embodiments, if the call is connected, a subsequent state of the graphical representation displays the contact details of the one of the most recent contacts.

A second graphical representation 220 represents various functions of a media application. The media application can generate multiple types of information for display by the media application. For example, the type of information includes playback and content browsing. The graphical representation 220 can display action soft buttons that control the media playback function such as previous 240, pause 242, and next 244. The automotive dual screen system selects the type of information to be displayed on the graphical representation while reserving the rest of the information to be displayed on a full screen mode when a user input is detected. A third graphical representation 222 represents various function of a navigation application. Note that while graphical representations 220-222 illustrate three examples of applications, the automotive dual screen system can be configured with different applications that generate different content for display.

In some embodiments, a carousel (not shown) can be displayed on the first screen 133a so the user can scroll horizontally (or vertically) to view additional graphical representations that are not currently visible to the user. The automotive dual screen system can utilize a progressive disclosure indication 250 on the first GUI 234a. The progressive disclosure indication 250 indicates that the first GUI 234a is not displaying all the graphical representations and that there are more graphical representations that are not currently being displayed. In this manner, the automotive dual screen system's decluttering features reduces, and potentially minimizes, the user's cognitive overload and helps users maintain the focus of their attention on driving, while ultimately providing an elevated user experience.

FIG. 2B is a diagram illustrating an example of an automotive dual screen system including a second graphical user interface (GUI) displaying two graphical representations responsive to user inputs. As illustrated, FIG. 2B depicts some embodiments of the automotive dual screen system 200 in which an application has been launched from the screen 133a to the second screen 133b. In some embodiments, the system can detect a user input related to one of the multiple graphical representations on the first GUI 234a. For example, the system detects when a user uses a touch gesture (e.g., tap) on the graphical representation 218 to answer an incoming call. In some other embodiments, the user uses a swipe gesture on the first graphical representation 218 on the GUI 234a of the screen 133a to cause the automotive dual screen system to take action with respect to one or more of the applications displaying content on the displays of the automotive dual screen system. The movement of a swipe gesture activates the instance and causes the automotive dual screen system to display the application on either the first screen 133a or the second screen 133b. In further embodiments, the touch gesture (e.g., tap) on a screen (e.g., 133a) activates the instance and causes the automotive dual screen system to display the application on the same screen (e.g., 133a).

In some embodiments, in response to the detecting the user input, the application corresponding to the selected graphical representation is launched on the screen 133b being different from the screen 133a. The application can be displayed on the GUI 234b of the screen 133b while the application on the GUI 234b of the screen 133a is displayed.

In some embodiments, the system detects a movement of a swipe gesture in a first direction on one of the multiple graphical representations. For example, the user swipes downward on the graphical representation 220 on the GUI 234b of the first screen 133a. In response to detecting that the user has made a swipe down gesture, the system launches the media application onto the GUI 234b in the screen 133b.

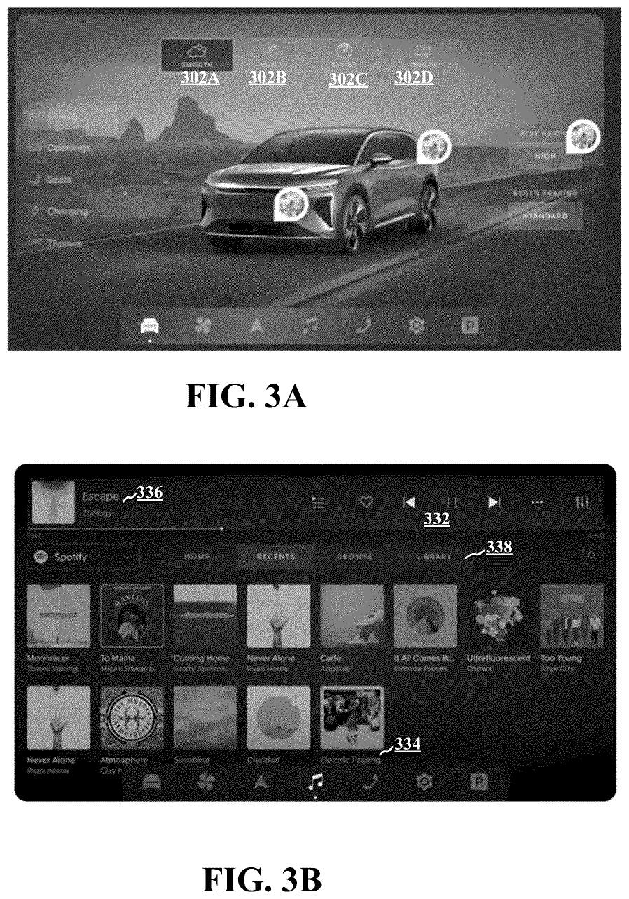

FIG. 2C is a diagram illustrating an example of an automotive dual screen system including a graphical user interface (GUI) displaying an expanded view of the graphical representation that includes more in-depth information of an associated application responsive to a user input. As shown, FIG. 2C depicts some embodiments of the automotive dual screen system 200 in which an application has been launched from screen 133a to the screen 133b resulting in the display of more in-depth information of the application. In some embodiments, the GUI 234b displays a detailed version of the graphical representation displayed on the GUI 234a. The GUI 234b also displays more in-depth information of the application and additional available options for the application that will be described in connection with FIGS. 3A-3B. For example, if the system displays the media application in and the driver wishes to browse other music contents on the media application and the automotive dual screen system does not support the browsing of music content in the graphical representation view, then the user can swipe down to launch an expanded view of the media application including more options on the screen 133b. This expanded screen being displayed on the screen 133b allows the user to browse the music content.

In some embodiments, a user can swipe down on a second graphical representation 220 on the GUI 234a of the screen 133a to cause the system to launch the graphical representation 220 on the GUI 234b of the screen 133b. The launching of the second graphical representation 220 on the second GUI 234b of the second screen 133b causes replacement of a graphical representation 218 that was previously displayed on the GUI 234b of the screen 133b. In this manner, one application can have two different instances of its output display being shown on two different screens. For example, a user can single tap on the graphical representation 222 and launch a full screen of a corresponding application on the screen 133a. Simultaneously, the user can still swipe down the graphical representation 222 to launch the graphical representation 222 on the screen 133b.

In some embodiments, the automotive dual screen system allows multi-tasking operations of an application by a passenger and the driver of a vehicle. In some embodiments, the automotive dual screen system updates the application on the screen 133a and the screen 133b. In some examples, the navigation application displays a route to a desired destination on a screen 133a. While the navigation application displays a route to a desired destination on the screen 133a, the passenger can perform a search of a nearby coffee shop on the screen 133b. Once the passenger locates the location of the nearby coffee shop and provides a user input to select the location of the nearby coffee shop (e.g., by touching the display), the system updates the active route on the screen 133a to display a route from the current location to the nearby coffee shop. In some other examples, if the driver updates the route on the first screen 133a, the automotive dual screen system will update the route displayed on the second screen 133b.

In some other embodiments, the automotive dual screen system updates the application on one screen but not on the other screen. In this manner, the automotive dual screen system allows multiple instances of an application being displayed on two different screen to function independently. In other words, there is no synchronization of the two such that an action performed on one screen does not affect the other screen. For example, a driver is playing a song from a Spotify playlist displayed on a screen 133a, and at the same time the passenger is browsing for a song on an iHeart radio on the screen 133b. The automotive dual screen system does not update the driver's instance on the GUI 234a of the screen 133a until the passenger presses a play button on the GUI 234b of the screen 133b. The two instances of the application can independently run on their respective screens.

In some embodiments, the automotive dual screen system updates shared data associated with the application on both screens. When a user interacts with the application on one of the screens, for example, the screen 133a, the shared data associated with the application is automatically updated on the other screen (e.g., screen 133b). For example, when a user switches a currently played track A to a track B on the screen 133a, the currently played track A is automatically changed to track B on the screen 133b.

In some embodiments, the automotive dual screen system updates a shared state associated with the application on both screens. When a user interacts with the application on one of the screens, for example, the screen 133a, the shared state associated with the application is automatically updated on the other screen (e.g., screen 133b). For example, when a user pauses a currently played track A on the screen 133a, the currently played track A is automatically paused on the screen 133b.

In some embodiments, the automotive dual screen system updates a shared state and shared data on both screens based on the last user's input. For example, when a user sets a first temperature (e.g., 72-degree Fahrenheit) on the screen 133a at a time t, and then the user sets a second temperature (e.g., 74-degree Fahrenheit) on the screen 133b at time t+1, the system updates both screens with the last user input (e.g., 74-degree Fahrenheit).

In some embodiments, the automotive dual screen system renders an independent view of the application for each screen based on different ranges of shared data and the last user's input. For example, when a user sets a first temperature (e.g., 72-degree Fahrenheit) on the screen 133a at a time t, and then the user sets a second temperature (e.g., 74-degree Fahrenheit) on the screen 133b at time t+1, the system updates both screens with the last user input (e.g., 74-degree Fahrenheit) while displaying a first view (e.g., 72-degree Fahrenheit) on the screen 133a and a second view (e.g., 74-degree Fahrenheit) on the screen 133b.

Referring to FIG. 2C, the GUI 234a of the first screen 133a can display an application launcher including selector system icons 116 representing applications such as home, navigation, media, and mobile phone that can be launched. In some embodiments, both the screen 133a and the screen 133b can display an application launcher. The screen 133b can include selector system icons 116 positioned at a region (e.g., the lower region, the upper region, the side) of the screen 133b. The selector system icons 116 being displayed on the screen 133b can be used by the user to directly tap these selector system icons 116 to launch an application on the screen 133b. In this manner, the user can not need to operate the screen 133a to swipe down one of the graphical representations to cause the system to launch the associated application on the screen 133b.

In some embodiments, the system detects a tap gesture on one of selector system icons representing an application. In response to the detecting the tap gesture, the application corresponding to one of the graphical representations is launched in a second region of the first GUI. For example, when a user performs a single tap gesture on a selector system icon representing a media application, the system launches media application 220 in a second region of the GUI 234a.

In some embodiments, at least a subset of the multiple graphical representations 218, 220, 222 can represent frequently used applications. In some other embodiments, at least a subset of the multiple graphical representations can be configured by the vehicle manufacturer. In some further embodiments, at least a subset of the multiple graphical representations can be configured by the user. For example, the user configures the graphical representation 218 to represent a mobile phone application.

In some embodiments, in response to detecting a second user input corresponding to a request to perform a function associated with the application, the associated application performs the requested function. In some embodiments, the output of performing the function can be simultaneously displayed on the two screens. For example, if a user wants to perform a function on the application (e.g., searching for an information using a search engine) on the screen 133a such as an individual using a search engine to search for a coffee shop, then the search engine generates a list of coffee shops along with corresponding locations. The application causes the system to display the list of coffee shops on GUI 234a along with corresponding locations on the screen 133a. The GUI 234b simultaneously displays the generated list of coffee shops along with corresponding locations on the screen 133b. Thereafter, the user can use the GUI 234b on the second screen 133b to review the list of coffee shops along with corresponding locations. The user can select the closest coffee shop on the second GUI 234b based on the user current location. In this manner, the user uses the screen 133b and not the screen 133a to perform a subsequent action although the user begins an initial action (or performed other previous actions) using the screen 133a.

FIG. 3A is diagram illustrating an example of an automotive dual screen system including a graphical user interface (GUI) displaying an expanded view of a graphical representation of an application that includes more in-depth information of an associated application. As illustrated, FIG. 3A depicts a GUI shown on a screen displays control selectors enabling the user to select configured drive modes. In some embodiments, the configured drive modes include smooth mode 302A, swift mode 302B, sapphire mode 302C, and track mode 302D. Each mode is designed for various conditions and styles, influencing the character of the car and behavior of suspension, steering, brakes, torque vectoring, peak power and torque, and thermal controls. Smooth mode 302A configures the vehicle for comfortable, effortless, highly efficient driving. Swift mode 302B configured the vehicle to maintain comfort while providing a distinctly sporty edge. Sapphire mode 302C combines unmatched power and torque with incredible reflexes and agility, for the ultimate on-road driving experience. Track mode 302D features three additional sub-modes, Dragstrip, Hot Lap, and Endurance, to further tune and condition the powertrain and battery for performance.

FIG. 3B is a diagram illustrating another example of an automotive dual screen system including a graphical user interface (GUI) displaying an expanded view of a graphical representation of an application that includes more in-depth information of the associated application. As shown, the expanded view of the graphical representation displayed on a second GUI shown on the second screen displays an expanded view of the graphical representation of the media application. The user can interact with the application directly from the second screen. In one embodiment, the expanded view of the graphical representation displays playback controls 332, media titles 334 for selection, a selected media title 336, and a menu bar 338.

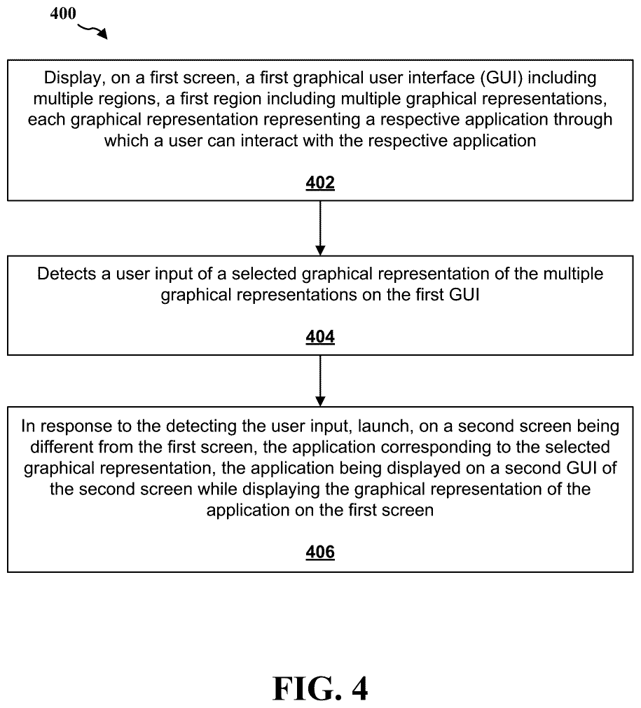

FIG. 4 is a flowchart 400 of a method of synchronizing a display of an application on multiple screens of a vehicle. The method can be performed by processing logic that can comprise hardware (e.g., circuitry, dedicated logic, programmable logic, a processor, a processing device, a CPU, a system-on-chip, etc.), software (e.g., instructions running/executing on a processing device), firmware (e.g., microcode), or a combination thereof. In some embodiments, at least a portion of the method can be performed based on aspects of FIGS. 1A-3B.

With reference to FIG. 4, the method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method can be performed in an order different than presented, and that not all of the blocks in the method can be performed.

The method begins at block 402, where processing logic displays, on a first screen, a first GUI including multiple regions, a first region including multiple graphical representations, each graphical representation representing a respective application through which a user can interact with the respective application (block 402). For example, referring to FIGS. 1A-1B, computing device 104 displays, on a screen 133a, a GUI 234a including multiple regions, a first region including multiple graphical representations, each graphical representation representing a respective application through which a user can interact with the respective application, as described above.

As also shown in FIG. 4, at block 404, processing logic detects a user input of a selected graphical representation of the multiple graphical representations on the first GUI (block 404). For example, referring to FIGS. 1A-1B, computing device 104 detects a user has touched (e.g., swiped on) screen 133a on one graphical representation of the multiple graphical representations being displayed on the GUI 234a, as described above.

As further shown in FIG. 4, at block 406, in response to the detecting the user input, processing logic launches the application, which generates content including a user interface that is displayed on a second screen that is different from the first screen through which the user's input was detected, where the application corresponds to the selected graphical representation. The application is displayed on a second GUI of the second screen while displaying the application on the first GUI of the first screen (block 406). For example, referring to FIGS. 1A-1B, in response to the detecting the user input, computing device 104 launches, on the screen 133b that is different from the screen 133a while displaying the graphical representation of the application on the first GUI 234a of the first screen 133a, as described above.

Although FIG. 4 shows example blocks of flowchart 400, in some implementations, flowchart 400 can include additional blocks, fewer blocks, different blocks, or differently arranged blocks than those depicted in FIG. 4. Additionally, or alternatively, two or more of the blocks of flowchart 400 can be performed in parallel.

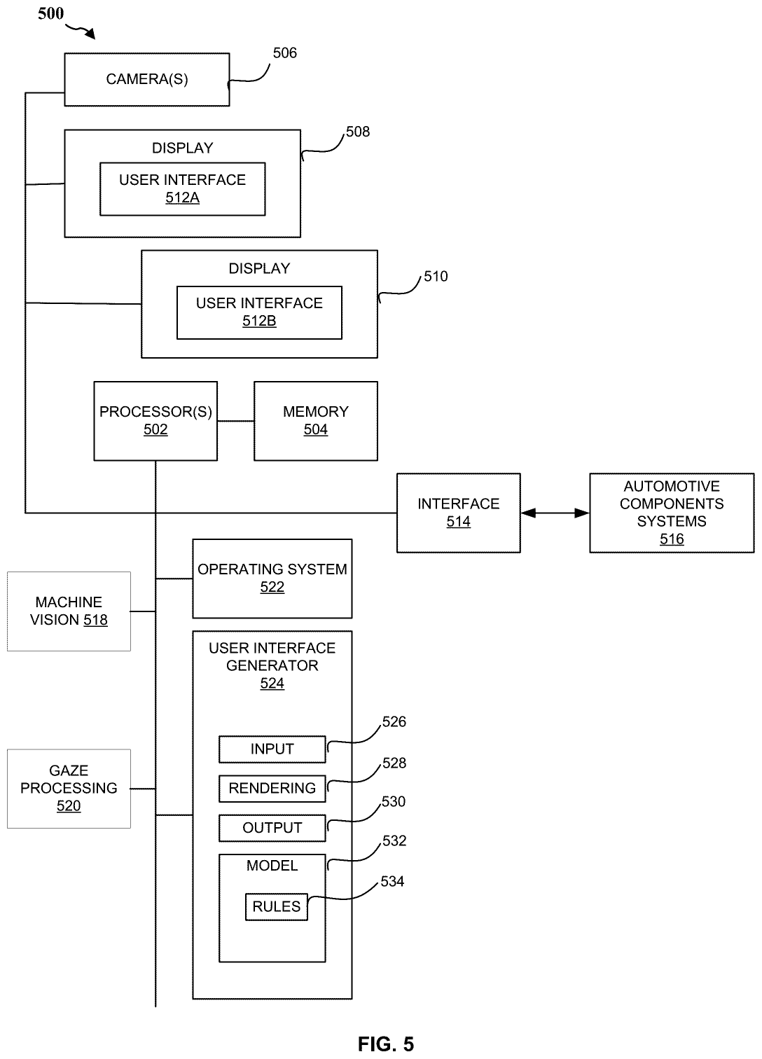

FIG. 5 is a block diagram 500 illustrating some embodiments of an automotive multiple screen system. Further embodiments of a multiple screen system that further includes speech detection, touch screens, touch pads, or other forms of user input devices, etc., are readily devised in keeping with the teachings herein.

One or more processors 502 coupled to memory 504 perform processing duties according to various software, hardware, firmware or combination modules. The processor(s) 502 and memory 504 are coupled to one or more cameras 506, a first display 508 (e.g., having a display screen) on which a user interface 512A is displayed, a second display 510 on which a user interface 512B is displayed, and an interface 514 that is or can be coupled to automotive components and systems 516 in order to control, adjust or otherwise provide input to such components and systems. Also, the processor(s) 502 and memory 504 are coupled to an operating system 522, a machine vision module 518, a gaze processing module 520, and a user interface generator 524. The user interface generator 524 has an input module 526, a rendering module 528, and output module 530, and in some embodiments includes a model 532 with rules 534. Other forms of models can be used in some embodiments. One form of implementation is special programming of the system, more specifically special programming of the processor(s) 502. It should be appreciated that structure of the various modules is determined by their functionality, in some embodiments.

In an operating scenario, which describes functionality of some embodiments, a driver or occupant of a vehicle is imaged by the camera(s) 506, while the driver views one, the other, or neither display 508, 510. Using the machine vision module 518, the system processes the imaging, and using the gaze processing module 520, the system determines driver gaze or occupant gaze. The determined gaze information is passed along through the input module 526 of the user interface generator 524, along with other input (e.g., touchscreen, touchpad, conventional control, etc., in some embodiments). The user interface generator 524 determines to change the display of the user interface 512A based on the determined gaze or other input information, interpreted as user input. With such changes to the user interface 512A based on the model 532 and rules 534 thereof, the system passes appropriate information to the rendering module 528 to generate display information for the updated user interface. In some embodiments, the model 532 includes a dual screen interaction model. In some embodiments, the model 532 includes a hide/reveal feature or a digital detox feature. This display information is output through the output module 530 of the user interface generator 524, to one, the other or both displays 508, 510, which then display the updated user interface, e.g., user interface 512A on one display 508 and/or user interface 512B on another display 510. In some embodiments, these displays 508, 510 are an upper display screen 133a and a lower display screen 133b (see, e.g., FIG. 1B) in an automobile or other vehicle. All of the above is coordinated through the operating system 522, which can be a real-time operating system. Further, the operating system 522 can receive from output module 530 from the user interface generator 524, and communicate user commands (from the user interface) through the interface 514 to automotive components and systems 516, for example to operate or provide input to such components and systems (e.g., audio/media system (which can be integrated), vehicle charging, seat adjustment, mirror adjustment, suspension settings, heating, ventilation and air conditioning operation, windows, door lock settings, etc.) It should be appreciated that machine vision could be integrated with or part of gaze processing, and vice versa, in some embodiments. It should be appreciated that the user interface generator 524 can be integrated with or part of the operating system 522, in some embodiments.

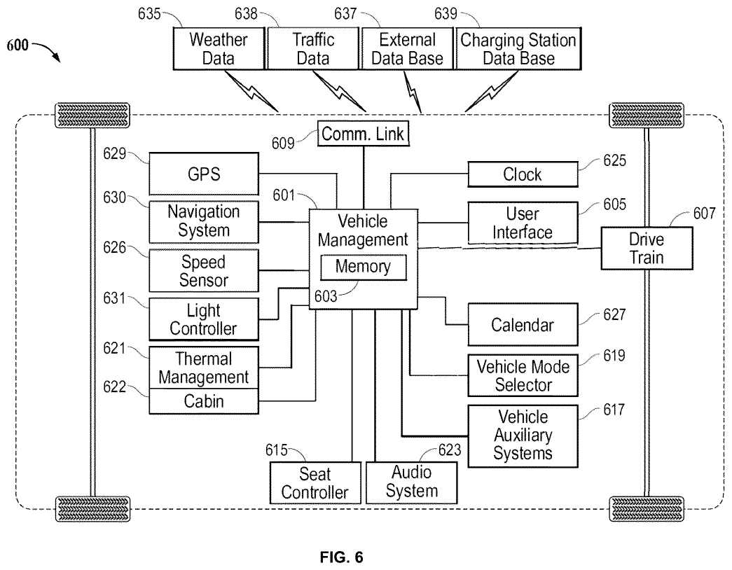

FIG. 6 is a high-level view of some embodiments of a vehicle 600. Vehicle 600 can be an electric vehicle (EV), a vehicle utilizing an internal combustion engine (ICE), or a hybrid vehicle, where a hybrid vehicle utilizes multiple sources of propulsion including an electric drive system. Vehicle 600 includes a vehicle on-board system controller 601, also referred to herein as a vehicle management system, which is comprised of a processor (e.g., a central processing unit (CPU)). System controller 601 also includes memory 603, with memory 603 being comprised of EPROM, EEPROM, flash memory, RAM, solid state drive, hard disk drive, or any other type of memory or combination of memory types. A user interface 605 is coupled to vehicle management system 601. Interface 605 allows the driver, or a passenger, to interact with the vehicle management system, for example inputting data into the navigation system 630, altering the heating, ventilation and air conditioning (HVAC) system via the thermal management system 621, controlling the vehicle's entertainment system (e.g., radio, CD/DVD player, etc.), adjusting vehicle settings (e.g., seat positions, light controls, etc.), and/or otherwise altering the functionality of vehicle 600. In at least some embodiments, user interface 605 also includes means for the vehicle management system to provide information to the driver and/or passenger, information such as a navigation map or driving instructions (e.g., via the navigation system 630 and GPS system 629) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 626), current HVAC settings such as cabin temperature and/or fan settings, etc.) via the thermal management system 621. Interface 605 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 600 can also include other features like an internal clock 625 and a calendar 627.

In some embodiments, user interface 605 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 605 includes a graphical display, controller 601 may also include a graphical processing unit (GPU), with the GPU being either separate from or contained on the same chip set as the processor.

Vehicle 600 also includes a drive train 607 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. System controller 601 monitors various vehicle functions that the driver may use to enhance the fit of the car to their own physical characteristics, such as seat position (e.g., seat position, seat height, seatback incline, lumbar support, seat cushion angle and seat cushion length) using seat controller 615 and steering wheel position using an auxiliary vehicle system controller 617. In some embodiments, system controller 601 also can monitor a driving mode selector 619 which is used to control performance characteristics of the vehicle (e.g., economy, sport, normal). In some embodiments, system controller 601 can also monitor suspension characteristics using auxiliary vehicle system 617, assuming that the suspension is user adjustable. In some embodiments, system controller 601 also monitors those aspects of the vehicle which are often varied by the user in order to match his or her environmental preferences for the cabin 622, for example setting the thermostat temperature or the recirculation controls of the thermal management system 621 that uses an HVAC controller, and/or setting the radio station/volume level of the audio system using controller 623, and/or setting the lights, either internal lighting or external lighting, using light controller 631. Also, besides using user-input and on-board sensors, system controller 601 can also use data received from an external on-line source that is coupled to the controller via communication link 609 (using, for example, GSM, EDGE, UMTS, CDMA, DECT, WiFi, WiMax, etc.). For example, in some embodiments, system controller 601 can receive weather information using an on-line weather service 635 or an on-line data base 637, traffic data 638 for traffic conditions for the navigation system 630, charging station locations from a charging station database 639, etc.

As an example, upon turning on the vehicle 600, in some embodiments, system controller 601 identifies the current driver (and go to their last pre-set functions) or just go the last pre-set functions for the vehicle (independent of who the current driver is), related to such features as: media functions, climate functions-heating, ventilation and air conditioning (HVAC) system, driving functions, seat positioning, steering wheel positioning, light control (e.g., internal lighting, external lighting, etc.), navigation functions, etc.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In some embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

The following aspects are illustrative only and may be combined with other aspects or teachings described herein, without limitation.

Example 1 is a method of synchronizing a display of an application on multiple screens of a vehicle, the method including displaying, on a first screen, a first graphical user interface (GUI) including multiple regions, a first region including multiple graphical representations, each graphical representation representing a respective application through which a user can interact with the respective application; detecting a user input on a selected graphical representation of the multiple graphical representations on the first GUI; in response to the detecting the user input, launching, on a second screen different from the first screen, the application corresponding to the selected graphical representation, the application being displayed on a second GUI of the second screen while displaying the graphical representation of the application on the first screen.

Example 2 may be combined with example 1 and further includes that the detecting the user input on the selected graphical representation of the multiple graphical representations including: detecting a swipe gesture made on the first screen in a first direction on one of the multiple graphical representations.

Example 3 may be combined with example 1 and further includes detecting a second gesture on one of selector system icons representing the graphical representations; and in response to the detecting the second gesture, launching the application corresponding to one of the graphical representations in a second region of the first GUI.

Example 4 may be combined with example 3 and further includes detecting the second gesture on the second region of the first GUI; and in response to detecting the second gesture, launching the application corresponding to the selected graphical representation of the graphical representations on the second screen.

Example 5 may be combined with example 4 and further includes that the second gesture includes at least one of: a single tap, a double tap, or a swipe.

Example 6 may be combined with example 1 and further includes that each graphical representation includes action GUI elements whose selection by a user causes performance of one or more functions associated with the application.

Example 7 may be combined with example 4 and further includes in response to detecting a second user input corresponding to a request to perform a function associated with the application; performing the function associated with the application, and simultaneously displaying, on the second screen, an outcome of performing the function while retaining a display of the outcome of performing the function on the first screen.

Example 8 may be combined with example 1 and further includes that at least a subset of the multiple graphical representations represents frequently used applications.

Example 9 may be combined with example 1 and further includes that the first screen and the second screen are juxtaposed in a predefined relative direction.

Example 10 is an apparatus for implementing a method as in any of Examples 1-9.

Example 11 is an apparatus including means for implementing a method as in any of Examples 1-9.

Example 12 is a non-transitory computer-readable medium storing computer executable code, the code when executed by at least one processor causes the at least one processor to implement a method as in any of Examples 1-9.

What is claimed is:

1. A method of synchronizing a display of an application on multiple screens of a vehicle, the method comprising:
displaying, on a first screen, a first graphical user interface (GUI) including multiple regions, a first region including multiple graphical representations, each graphical representation representing a respective application through which a user can interact with the respective application;
detecting a user input on a selected graphical representation of the multiple graphical representations on the first GUI; and
in response to the detecting the user input, launching, on a second screen different from the first screen, the application corresponding to the selected graphical representation, the application being displayed on a second GUI of the second screen while displaying the graphical representation of the application on the first screen.

2. The method of claim 1, wherein the detecting the user input on the selected graphical representation of the multiple graphical representations comprises:
detecting a swipe gesture made on the first screen in a first direction on one of the multiple graphical representations.

3. The method of claim 1 further comprising:
detecting a second gesture on one of selector system icons representing the graphical representations; and
in response to the detecting the second gesture, launching the application corresponding to one of the graphical representations in a second region of the first GUI.

4. The method of claim 3, further comprising:
detecting the second gesture on the second region of the first GUI; and
in response to detecting the second gesture, launching the application corresponding to the selected graphical representation of the graphical representations on the second screen.

5. The method of claim 3, wherein the second gesture includes at least one of: a single tap, a double tap, or a swipe.

6. The method of claim 1, wherein each graphical representation includes action GUI elements whose selection by a user causes performance of one or more functions associated with the application.

7. The method of claim 4, further comprising:
in response to detecting a second user input corresponding to a request to perform a function associated with the application;
performing the function associated with the application, and
displaying, on the second screen, an output resulting from performance of the function.

8. The method of claim 1, wherein at least a subset of the multiple graphical representations represents frequently used applications.

9. The method of claim 1, wherein the first screen and the second screen are juxtaposed in a predefined relative direction.

10. A system for synchronizing a display of an application on multiple screens of a vehicle comprising:
one or more processors configured to:
display, on a first screen, a first graphical user interface (GUI) including multiple regions, a first region including multiple graphical representations, each graphical representation representing a respective application through which a user can interact with the respective application;
detect a user input on a selected graphical representation of the multiple graphical representations on the first GUI; and
in response to the detecting the user input, launch, on a second screen different from the first screen, the application corresponding to the selected graphical representation, the application being displayed on a second GUI of the second screen while displaying the graphical representation of the application on the first screen.

11. The system of claim 10, wherein the detecting the user input on the selected graphical representation of the multiple graphical representations comprises:
detecting a swipe gesture made on the first screen in a first direction on one of the multiple graphical representations.

12. The system of claim 10, further comprising:
detecting a second gesture on one of selector system icons representing the graphical representations; and
in response to the detecting the second gesture, launching the application corresponding to one of the graphical representations in a second region of the first GUI.

13. The system of claim 12, further comprising:
detecting the second gesture on the second region of the first GUI; and
in response to detecting the second gesture, launching the application corresponding to the selected graphical representation of the graphical representations on the second screen.

14. The system of claim 12, wherein the second gesture includes at least one of: a single tap, a double tap, or a swipe.

15. The system of claim 13, further comprising:
in response to detecting a second user input corresponding to a request to perform a function associated with the application
performing the function associated with the application, and
displaying, on the second screen, an output resulting from performance of the function.

16. The system of claim 10, wherein each graphical representation includes action GUI elements whose selection by a user causes performance of one or more functions associated with the application.

17. The system of claim 10, wherein at least a subset of the multiple graphical representations represents frequently used applications.

18. The system of claim 10, wherein the first screen and the second screen are juxtaposed in a predefined relative direction.

19. A non-transitory computer-readable medium storing a set of instructions for synchronizing a display of an application on multiple screens of a vehicle, the set of instructions comprising:
one or more instructions that, when executed by one or more processors of a device, cause the device to:
display, on a first screen, a first graphical user interface (GUI) including multiple regions, a first region including multiple graphical representations, each graphical representation representing a respective application through which a user can interact with the respective application;
detect a user input on a selected graphical representation of the multiple graphical representations on the first GUI; and
in response to the detecting the user input, launch, on a second screen different from the first screen, the application corresponding to the selected graphical representation, the application being displayed on a second GUI of the second screen while displaying the graphical representation of the application on the first screen.

20. The non-transitory computer-readable medium of claim 19, wherein the one or more instructions, when the detecting the user input on the selected graphical representation of the multiple graphical representations, cause the device to:
detect a swipe gesture made on the first screen in a first direction on one of the multiple graphical representations.
